(19) United States
(12) Patent Application Publication
(10) Pub. No.: US 2025/0039293 A1
(43) Pub. Date: Jan. 30, 2025

(54) CLOUD-BASED SMART ACCESSORY SYSTEM

(71) Applicant: Samsung Electronics Co., Ltd., Suwon-si (KR)

(72) Inventors: Youngho RHEE, Suwon-si (KR); Junghun KIM, Suwon-si (KR)

(21) Appl. No.: 18/790,523

(22) Filed: Jul. 31, 2024

Related U.S. Application Data
(63) Continuation of application No. PCT/KR2023/002731, filed on Feb. 27, 2023.

(30) Foreign Application Priority Data
Apr. 21, 2022 (KR) 10-2022-0049460
Jun. 27, 2022 (KR) 10-2022-0078406

(51) Int. Cl. H04M 1/72469; H04M 1/72412

(52) U.S. Cl. CPC H04M 1/72469; H04M 1/72412

(57) ABSTRACT

Various embodiments of the present disclosure relate to a cloud-based smart accessory system, and comprise: an accessory that includes at least one button, a first communication interface comprising communication circuitry, and at least one first processor comprising processing circuitry, configured to communicate with an electronic device via the first communication interface; and the electronic device that includes: a second communication interface comprising communication circuitry, a third communication interface comprising communication circuitry, and at least one second processor comprising processing circuitry, individually and/or collectively, configured to: communicate with the accessory via the second communication interface, and communicate with a server via the third communication interface, wherein at least one second processor, individually and/or collectively, may be configured to control the electronic device to: receive accessory information from the accessory; transmit the accessory information (or some information) to the server; and receive, from the server, at least one of an associated application, an associated GUI resource, and associated content that have been determined by the server based on the accessory information (or the some information), or a service address of at least one external apparatus that may acquire at least one of the associated application, the associated GUI resource, and the associated content.

### CROSS-REFERENCE TO RELATED APPLICATIONS

This application is a continuation of International Application No. PCT/KR2023/002731 designating the United States, filed on Feb. 27, 2023, in the Korean Intellectual Property Receiving Office and claiming priority to Korean Patent Application Nos. 10-2022-0049460, filed on Apr. 21, 2022, and 10-2022-0078406, filed on Jun. 27, 2022, in the Korean Intellectual Property Office, the disclosures of each of which are incorporated by reference herein in their entireties.

### BACKGROUND

### Field

The disclosure relates to a cloud-based smart accessory system and a method thereof, and to a cloud-based smart accessory system and a method thereof, which may provide, for example, an accessory (e.g., a case, a card, or a sticker) couplable to an electronic device (e.g., a mobile terminal), provide the electronic device with a service associated with the accessory through a server, and dynamically map an associated service to hardware, such as an accessory button, or a lock screen.

### Description of Related Art

As various functions are supported through applications in electronic devices such as mobile terminals, shortcuts may be provided on a lock screen or hardware physical buttons may be provided to enhance ease of use of electronic devices.

Further, an NFC-based button sticker, as an accessory of an electronic device, and an application related thereto may be provided by an application product manufacturer.

The hardware physical button, the shortcut of the lock screen, or the external button of the accessory may execute a predefined function in the electronic device by user settings or the like.

When providing an accessory platform that may be coupled or connected to an electronic device and dynamically map and provide an associated service to, e.g., an accessory button through a server, the electronic device that may be dynamically customized through the accessory may be provided to enterprise customers and the like, and the ease of use of the electronic device may be increased.

### SUMMARY

Embodiments of the disclosure provide a cloud-based smart accessory system and a method thereof which may provide an accessory including, e.g., at least one button couplable or connectable to an electronic device, allow the electronic device to receive, from a server, e.g., an application/graphical user interface (GUI) resource/content associated with the accessory, determined by the server based on accessory information, and dynamically map the associated application or so received from the electronic device to a button of the accessory or the shortcut of the lock screen.

According to an example embodiment of the disclosure, a smart accessory system may comprise: an accessory including at least one button, a first communication interface comprising communication circuitry, and at least one first processor comprising processing circuitry, and configured to communicate with an electronic device through the first communication interface, and an electronic device including a second communication interface comprising communication circuitry, a third communication interface comprising communication circuitry, and at least one second processor comprising processing circuitry, configured to communicate with the accessory through the second communication interface, and configured to communicate with a server through the third communication interface. At least one second processor, individually and/or collectively, may be configured to: receive accessory information from the accessory, transmit the accessory information or the partial information of the accessory information to the server, and receive, from the server, at least one of an associated application, an associated GUI resource, and associated content, or a service address of at least one external device capable of obtaining at least one of the associated application, the associated GUI resource, and the associated content, determined by the server based on the accessory information or the partial information of the accessory information.

According to an example embodiment of the disclosure, a server may comprise: a communication interface comprising communication circuitry, a database including at least one of associated application information, associated GUI resource information, and associated content information, for each of accessory information corresponding to an accessory coupled to an electronic device or partial information of the accessory information, and at least one processor comprising processing circuitry. At least one processor, individually and/or collectively, may be configured to: receive the accessory information or the partial information of the accessory information from the electronic device, determine at least one of the associated application information, the associated GUI resource information, and the associated content information based on the accessory information or the partial information of the accessory information in the database, and transmit, through the communication interface, to the electronic device, at least one of an associated application obtained based on the associated application information, an associated GUI resource obtained based on the associated GUI resource information, and associated content obtained based on the associated content information or a service address of at least one external device capable of obtaining at least one of the associated application, the associated GUI resource and the associated content.

According to an example embodiment of the disclosure, a method for providing a smart accessory by an electronic device may comprise: receiving accessory information from an accessory including at least one button, transmitting the accessory information or partial information of the accessory information to a server, and receiving, from the server, at least one of an associated application, an associated GUI resource, and associated content, or a service address of at least one external device capable of obtaining at least one of the associated application, the associated GUI resource, and the associated content, determined by the server based on the accessory information or the partial information of the accessory information.

According to an example embodiment of the disclosure, a method for providing a smart accessory by a server may comprise: receiving accessory information corresponding to an accessory coupled to an electronic device or partial information of the accessory information from the electronic device, determining at least one of associated application information, associated GUI resource information, and associated content information, based on the accessory information or the partial information of the accessory information, and transmitting, to the electronic device, at least one of an associated application obtained based on the associated application information, an associated GUI resource obtained based on the associated GUI resource information, and associated content obtained based on the associated content information or a service address of at least one external device capable of obtaining at least one of the associated application, the associated GUI resource and the associated content.

According to various example embodiments of the disclosure, there may be provided a smart accessory system that may provide an accessory couplable or connectable to an electronic device and dynamically map an associated service to, e.g., an accessory button through a server. Further, when an accessory further including a UWB module and an antenna is provided, additional services such as a UWB module- and antenna-based real time tracking system (RTLS) may be provided by coupling or connecting the accessory and the electronic device even if the electronic device is not equipped with a UWB module and an antenna.

According to various example embodiments of the disclosure, through a cloud-based server and an accessory couplable or connectable to an electronic device, it is possible to provide a differentiated electronic device that may be dynamically customized to enterprise customers, etc., increase the ease of use of the electronic device, and promote high value-added product sales.

Effects achievable by various example embodiments of the disclosure are not limited to the above-mentioned effects, but other effects not mentioned may be derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example smart accessory system according to various embodiments;

FIG. 2 is a diagram illustrating an example accessory button and an example shortcut of a lock screen capable of dynamic mapping of an associated service according to various embodiments;

FIG. 3 is a block diagram illustrating example configurations of an electronic device and an accessory of a smart accessory system according to various embodiments;

FIG. 4 is a perspective view illustrating an example case-shaped accessory according to various embodiments;

FIG. 5 includes a perspective view and diagrams illustrating an example case-shaped accessory further including a UWB module and an antenna according to various embodiments;

FIG. 6 is a flowchart illustrating an example method for providing a smart accessory by an electronic device according to various embodiments;

FIG. 7 is a flowchart illustrating an example method for providing a smart accessory by a server according to various embodiments;

FIG. 8 is a block diagram illustrating an example configuration of an electronic device of a smart accessory system providing an RTLS service according to various embodiments;

FIG. 9 is a flowchart illustrating an example method for providing an RTLS service by an electronic device of a smart accessory system according to various embodiments; and

FIG. 10 is a block diagram illustrating an example electronic device in a network environment according to various embodiments.

### DETAILED DESCRIPTION

Hereinafter, various example embodiments of the disclosure are described in greater detail with reference to the drawings. However, the disclosure may be implemented in other various forms and is not limited to the various example embodiments set forth herein. The same or similar reference denotations may be used to refer to the same or similar elements throughout the disclosure, including the drawings. Further, for clarity and brevity, no description is made of well-known functions and configurations in the drawings and relevant descriptions.

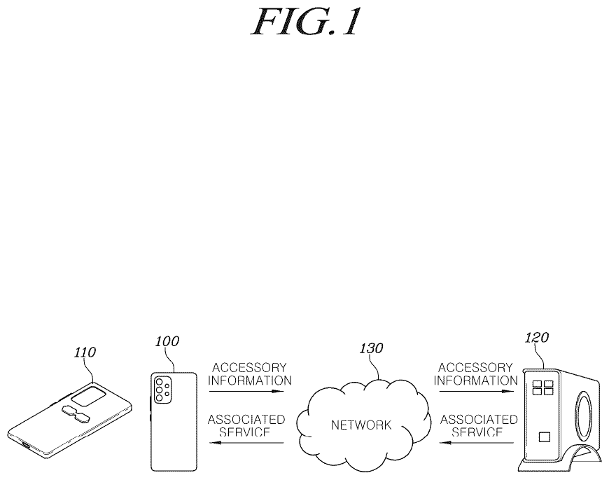

FIG. 1 is a diagram illustrating an example smart accessory system according to various embodiments.

Referring to FIG. 1, a smart accessory system may include an accessory 110 and an electronic device 100 that may be coupled or connected to an electronic device. The electronic device 100 may communicate with a server 120 through a network 130.

The accessory 110 may be coupled to the electronic device 100 in a shape of one of a case, a card, and a sticker, or may be connected to the electronic device 100 as a remote control, but it will be apparent to one of ordinary skill in the art that the shape of the accessory 110 is not limited thereto and may be provided in various shapes. The accessory 110 may include at least one button.

The electronic device 100 may determine whether the accessory 110 is coupled or connected. For example, when the accessory 110 and the electronic device 100 are coupled by magnetism, the electronic device 100 may determine whether the accessory 100 is coupled by sensing whether the accessory 110 is coupled by magnetism.

When the accessory 110 is coupled or connected to the electronic device 100, the electronic device 100 may obtain accessory information from the accessory 110. The accessory information may include information capable of identifying the accessory type. The electronic device 100 may transmit accessory information or partial information of the accessory information to the server 120 through the network 130.

The server 120 may include a database (not shown), and the database may include associated service information for each of the accessory information or partial information of the accessory information. The associated service information may include at least one of associated application information, associated GUI resource information, and associated content information associated to the accessory.

The server 120 may determine at least one of the associated application information, associated GUI resource information, and associated content information associated with the accessory 110 based on the accessory information or partial information of the accessory information received from the electronic device 100 using the database. The server 120 may obtain the associated application using the associated application information, obtain the associated GUI resource using the associated GUI resource information, or obtain associated content using the associated content information. For example, the server 120 may obtain the associated application from an app store (not shown) connected through the network 130 or a storage medium inside the server 120 based on the associated application information, but the method by which the server 120 may obtain the associated application or the like is not limited thereto. The server 120 may transmit at least one of the associated application, the associated GUI resource, and the associated content to the electronic device 100. The server 120 may transmit a service address of at least one external device (not shown) capable of obtaining at least one of the associated application, the associated GUI resource, and the associated content to the electronic device 100.

The electronic device 100 may receive at least one of the associated application, the associated GUI resource, and the associated content from the server 120 or the external device and install it. The electronic device 100 may map at least one of the associated application, the associated GUI resource, and the associated content to at least one button of the accessory 110 or at least one shortcut of the lock screen of the electronic device 100, respectively.

In the accessory 110 coupled with the electronic device 100, when a predetermined button of the at least one button is input by a user or a specific shortcut of the lock screen is touched by the user, the mapped associated application may be executed or a predetermined function of the associated application may be executed.

According to various embodiments, the network 130 may include a short-range communication network, such as wireless fidelity (Wi-Fi), or a remote communication network, such as a cellular network, a next-generation communication network, the Internet, or a computer network (e.g., LAN or WAN), and may communicate based on an IP communication protocol. The cellular network may include global system for mobile communications (GSM), enhanced data GSM environment (EDGE), code division multiple access (CDMA), time division multiplexing access (TDMA), 5G, long-term evolution (LTE), and LTE-advanced (LTE-A). The network 130 may include connections of network components, such as hubs, bridges, routers, switches, and gateways. The network 130 may include one or more connected networks, e.g., a multi-network environment, including public networks such as the Internet and private networks such as safe business private networks. Access to the network 130 may be provided via one or more wired or wireless access networks. Further, the network 130 may support Internet-of-things (IoT) networks, which exchange information between distributed components, e.g., things, and process the information.

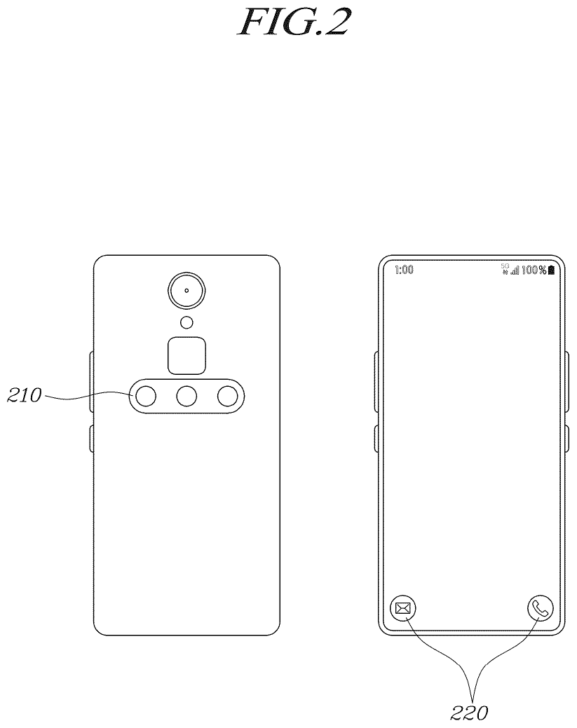

FIG. 2 is a diagram illustrating an example accessory button and an example shortcut of a lock screen capable of dynamic mapping of an associated service according to various embodiments.

In the illustrated example, the accessory 210 may have the shape of an NFC-based button sticker and may include, for example, and without limitation, three buttons. When a predetermined button is input by the user in the accessory 210 coupled with the electronic device 100, an application associated to the predetermined button mapped through the server 120 may be executed or a predetermined function of the associated application may be executed.

Further, in the illustrated example, the electronic device 100 may display at least one shortcut 220 on the lock screen. When a specific shortcut is touched by the user, an application associated to the specific shortcut mapped through the server 120 may be executed or a predetermined function of the associated application may be executed.

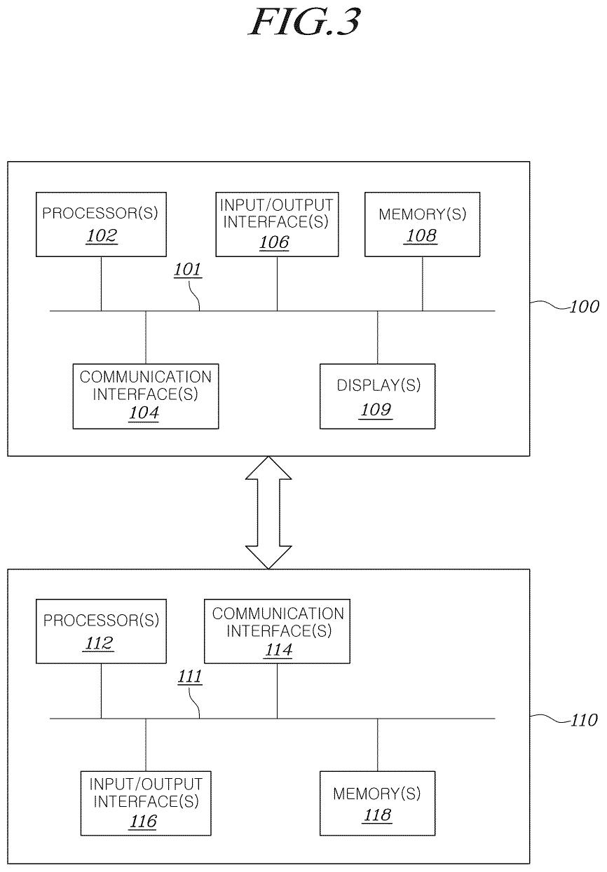

FIG. 3 block diagrams illustrating example configurations of an electronic device and an accessory of a smart accessory system according to various embodiments.

Referring to FIG. 3, the accessory 110 may include a processor(s) (e.g., including processing circuitry) 112, a communication interface(s) (e.g., including communication circuitry) 114, an input/output interface(s) (e.g., including various circuitry) 116, and a communication bus(s) 111 for interconnecting various other components. The accessory 110 may further include a memory(s) 118 coupled to the bus(s) 111 and capable of storing information and instructions to be executed by the processor(s) 112. The accessory 110 may further include a charger (not shown) for charging the accessory 110 with power. Further, the accessory 110 may further include an antenna including at least one of a directional antenna and a non-directional antenna and a UWB module. The accessory 110 may include additional components in addition to the illustrated components, or may omit at least one of the illustrated components.

According to an embodiment, the memory(s) 118 may include accessory information. The accessory information may include a service policy associated with the accessory 110, a service ID, and a serial number of the accessory 110. The service policy may include a dynamic lock screen service, a custom service, an external device interworking service, and a lite service. The dynamic lock screen service may refer to a service that provides a specialized service such as a music/image streaming service by changing the lock screen of the electronic device 100. The custom service may refer to a service that provides customized application/GUI resources to the lock screen of the electronic device 100. The external device interworking service may refer to a service that maps associated applications to accessory buttons, etc. without changing the GUI resource of the electronic device 100. The lite service may refer to a service that provides a separate screen on the lock screen or the home screen without additionally installing an application or GUI resource in the electronic device 100. The service ID may include an accessory type. The accessory type may include at least one of a button case, a general case, a charger, a cable, and a pad. The service ID may further include a serial number. The service ID may refer to an identification number of a business to business (B2B) service (or a B2B project) associated with the accessory 110. The serial number may indicate a hardware serial number of the accessory 110. It will be apparent to one of skill in the art that the service policy, service ID, and accessory information illustrated above are not limited thereto but may be variously configured.

The input/output interface(s) 116 may include various circuitry including, for example, at least one button. When a predetermined button among the at least one button is input by the user, an associated application or a predetermined function of the associated application, mapped to each of the at least one button, may be executed by the electronic device 100.

The communication interface(s) 114 may include various communication circuitry including, for example, a first communication interface communicating with the electronic device. The first communication interface may be implemented as one of NFC, USB, and Bluetooth, but it will be apparent to one of skill in the art that the first communication interface is not limited thereto. When the first communication interface is implemented as USB, the charger may charge power from the electronic device 100 or an external power outlet through the first communication interface.

The processor(s) 112 may include various processing circuitry, including, for example, at least one of a micro controller unit (MCU), a sensor hub processor, a supplementary processor, a communication processor, an application processor, a central processing unit (CPU), an application specific integrated circuit (ASIC), and a field programmable gate array (FPGA). The processor(s) 112 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

When the accessory 110 is coupled or connected to the electronic device 100, the processor(s) 112 may transmit the accessory information to the electronic device 100 through the first communication interface.

The antenna may transmit and receive a wireless signal to and from at least one UWB anchor positioned indoors.

The UWB module may calculate a distance between the positioning target and the at least one UWB anchor by interworking with the at least one UWB anchor, and may obtain position information about the positioning target.

The processor(s) 112 may transmit position information about the positioning target obtained by the UWB module to the electronic device 100 through the first communication interface.

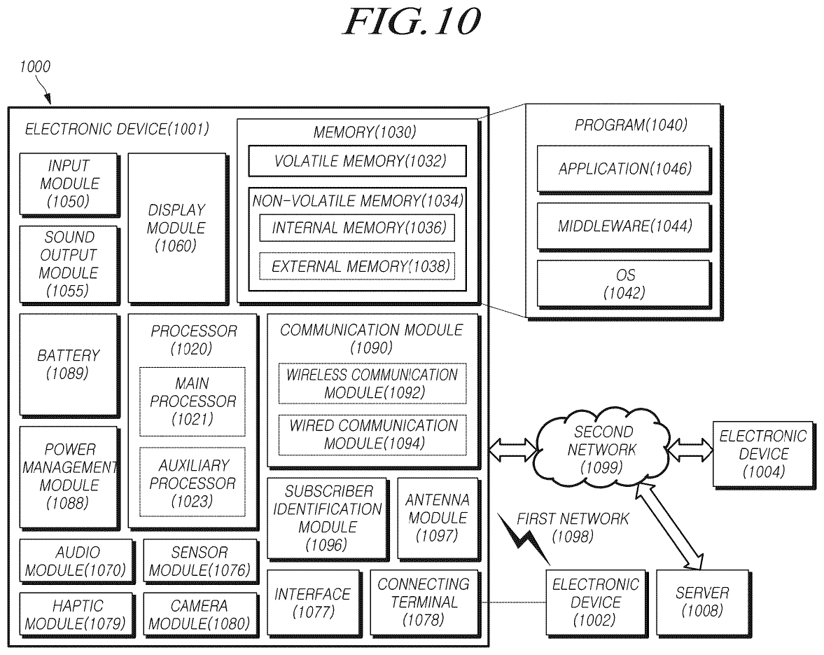

Referring to FIG. 3, an electronic device 100 may include a processor(s) (e.g., including processing circuitry) 102, a communication interface(s) (e.g., including communication circuitry) 104, an input/output interface(s) (e.g., including various circuitry) 106, a display(s) 109, and a communication bus(s) 101 for interconnecting such various components. The electronic device 100 may further include a memory(s) 108 coupled to the bus(s) 101 and capable of storing information and instructions to be executed by the processor(s) 102. The electronic device 100 may correspond to the electronic device 1000 of FIG. 10, but may include additional components other than the illustrated components or may omit at least one of the illustrated components.

According to an embodiment, the communication interface(s) 104 may include various communication circuitry including, for example, a second communication interface and a third communication interface. It will be apparent to one of skill in the art that the second communication interface communicates with the accessory 110 and may be implemented as one of NFC, USB, and Bluetooth, but is not limited thereto. The third communication interface may communicate with the server 120 through the network 130.

The processor(s) 102 may include various processing circuitry and determine whether the accessory 110 is coupled or connected. For example, when the accessory 110 and the electronic device 100 are coupled by magnetism, the processor(s) 102 may determine whether the accessory 110 is coupled by sensing whether the accessory 110 is coupled by magnetism. The processor(s) 102 may determine whether the accessory 110 is connected through signal transmission/reception through the second communication interface. The processor(s) 102 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

When the accessory 110 is coupled or connected to the electronic device 100, the processor(s) 102 may receive the accessory information from the accessory 110 through the second communication interface. The processor(s) 102 may execute a predetermined application based on the accessory type among the accessory information. For example, the predetermined application may be an accessory manager application.

The processor(s) 102 may transmit the accessory information or partial information of the accessory information to the server 120 through the third communication interface. The partial information of the accessory information may include the service ID. The processor(s) 102 may receive at least one of an associated application, an associated GUI resource, and associated content determined by the server 120 based on the accessory information or partial information of the accessory information from the server 120. The associated GUI resource may include a GUI resource such as a wallpaper and a shortcut icon. The processor(s) 102 may automatically install the associated application or the associated GUI resource or automatically play the associated content. Alternatively, the processor(s) 102 may receive a service address (e.g., a URL) of at least one external device (not shown) capable of obtaining at least one of the associated application, the associated GUI resource, and the associated content from the server 120. The processor(s) 102 may install the associated application or the associated GUI resource or play the associated content based on a user input to the corresponding service address of the external device.

The processor(s) 102 may map the execution of the associated application or the execution of a predetermined function of the associated application to at least one button of the accessory 110 or at least one shortcut of the lock screen of the electronic device 120, respectively. When a specific button of the at least one button is input by the user or a specific shortcut of the lock screen is touched by the user, the processor(s) 102 may execute the mapped associated application or execute the predetermined function of the associated application.

The predetermined application may perform the operation of transmitting the accessory information or the partial information of the accessory information to the server 120, the operation of receiving, from the server 120, at least one of the associated application, associated GUI resource and associated content or a service address of at least one external device capable of obtaining at least one of the associated application, associated GUI resource and associated content, and the operation of executing the mapped associated application or predetermined function of the associated application when a specific button of the at least one button is input or a specific short key of the lock screen is touched by the user.

The server 120 may include a communication interface (not shown), a database (not shown), and at least one processor.

The communication interface may communicate with the electronic device 100 through the network 130.

The database may include at least one of associated application information, associated GUI resource information, and associated content information for each of the accessory information corresponding to the accessory 110 coupled to electronic device 100 or partial information of the accessory information. For example, the associated application information may include an installation package name of the associated application or a URL address capable of installing the associated application. The associated GUI resource may include a wallpaper and a shortcut icon, and the associated GUI resource information may include a GUI resource identifier or a URL address providing a GUI resource for each of the associated GUI resources.

The at least one processor may receive the accessory information or partial information of the accessory information from the electronic device 100. The at least one processor may determine at least one of the associated application information, the associated GUI resource information, and the associated content information based on the accessory information or partial information of the accessory information using the database. The at least one processor may transmit at least one of an associated application obtained based on the associated application information, an associated GUI resource obtained based on the associated GUI resource information, and associated content obtained based on the associated content information to the electronic device 100. For example, the server 120 may obtain the associated application from an app store (not shown) connected through the network 130 or a storage medium inside the server 120 based on the associated application information, but it will be apparent to one of skill in the art that the method by which the server 120 may obtain the associated application or the like is not limited thereto. Alternatively, the server 120 may transmit a service address (e.g., a URL) of at least one external device (not shown) capable of obtaining at least one of the associated application, the associated GUI resource, and the associated content to the electronic device 100.

Some functional components illustrated in FIG. 3 may be implemented in a single module or one or more modules. The actual number of modules, the division of specific functions, and how features are internally allocated may vary from implementation to implementation, and in some implementations, may at least depend on a specific combination of hardware, software, or firmware selected for the specific implementations.

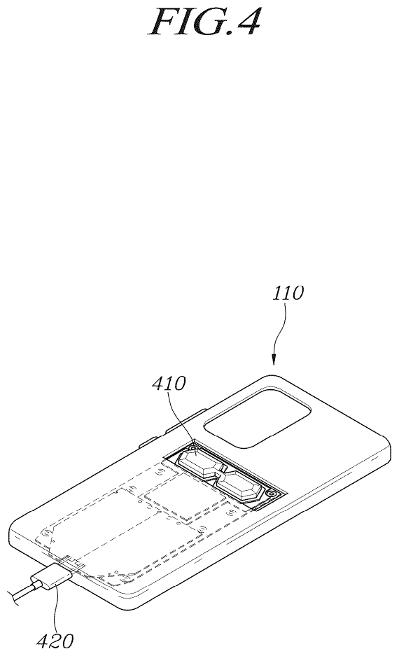

FIG. 4 is a perspective view illustrating an example case-shaped accessory according to various embodiments.

Referring to FIG. 4, the input/output interface(s) 116 of the accessory 110 may include at least one button 410. When a specific button of the at least one button is input by the user, an associated application or a predetermined function of the associated application, mapped to the specific button, may be executed by the electronic device 100.

Referring to FIG. 4, when the first communication interface of the accessory 110 is implemented as USB, the charger may charge power from the electronic device 100 or an external power outlet through a USB connection 420.

Referring to FIG. 4, a printed circuit board (PCB) mounted in the accessory 110 may include a processor(s) 112, a communication interface(s) 114, an input/output interface(s) 116, a communication bus(s) 111, a memory(s) 118, and the charger.

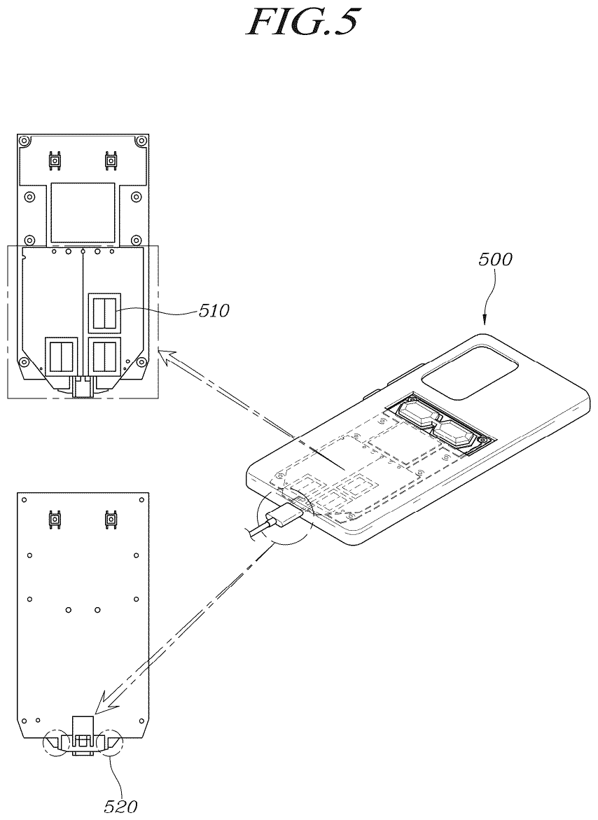

FIG. 5 includes diagrams and a perspective view illustrating an example case-shaped accessory further including a UWB module and an antenna according to various embodiments.

Referring to FIG. 5, the accessory 500 may include a three-port directional antenna 510 on the printed circuit board and a non-directional antenna 520 positioned at a lower end of the accessory 500. The UWB module may be mounted at a predetermined position of the printed circuit board.

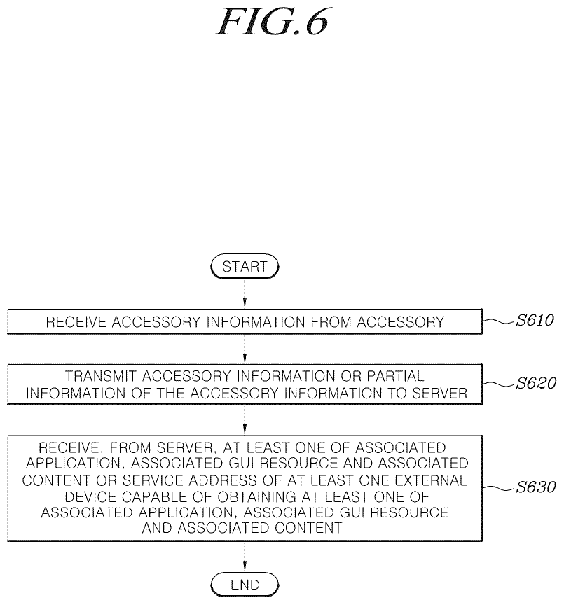

FIG. 6 is a flowchart illustrating an example method for providing a smart accessory by an electronic device according to various embodiments.

Referring to FIG. 6, in operation S610 according to an embodiment, the electronic device 100 may receive accessory information from the accessory 110 including at least one button. The accessory information may include a service policy associated with the accessory 110, a service ID, and a serial number of the accessory 110. The service ID may include an accessory type. The accessory type may include at least one of a button case, a general case, a charger, a cable, and a pad. The electronic device 100 may execute a predetermined application based on the accessory type.

In operation S620, the electronic device 100 may transmit the accessory information or partial information of the accessory information to the server 120. The partial information of the accessory information may include a service ID.

In operation S630, the electronic device 100 may receive, from the server 120, at least one of an associated application, an associated GUI resource and associated content or a service address of at least one external device capable of obtaining at least one of the associated application, associated GUI resource, and associated content, determined based on the accessory information or the partial information of the accessory information by the server 120.

The electronic device 100 may map the execution of the associated application or the execution of a predetermined function of the associated application to at least one button of the accessory 110 or at least one shortcut of the lock screen, respectively.

The operation of transmitting the accessory information or partial information of the accessory information to the server 120 and the operation of receiving at least one of the associated application, the associated GUI resource, and associated content from the server 120 may be performed by the predetermined application.

When a specific button of the at least one button is input or a specific shortcut of the lock screen is touched by the user, the electronic device 100 may execute the mapped associated application or execute the predetermined function of the associated application.

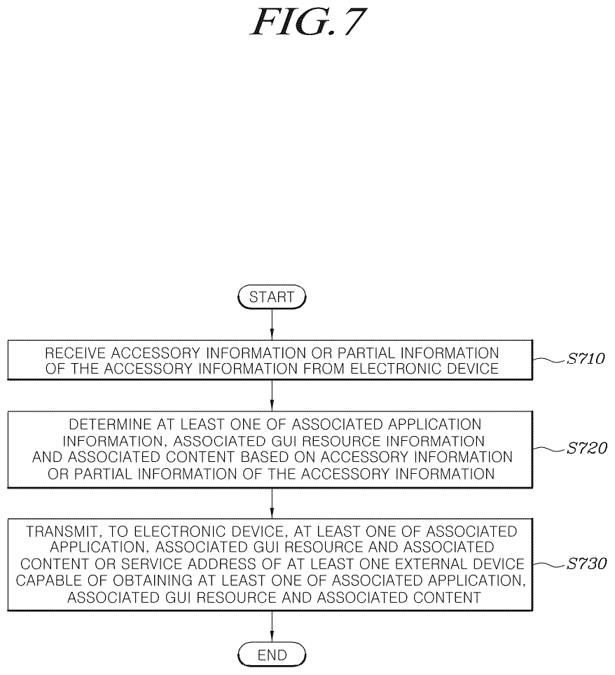

FIG. 7 is a flowchart illustrating an example method for providing a smart accessory by a server according to various embodiments.

The server 120 may store at least one of the associated application information, associated GUI resource information, and associated content information for each of the accessory information or partial information of the accessory information in a database.

Referring to FIG. 7, in operation S710 according to an embodiment, the server 120 may receive accessory information corresponding to an accessory coupled to the electronic device 100 or partial information of the accessory information from the electronic device 100.

In operation S720, the server 120 may determine at least one of the associated application information, the associated GUI resource information, and the associated content information using the database, based on the accessory information or partial information of the accessory information.

In operation S730, the server 120 may transmit, to the electronic device 100, at least one of an associated application obtained based on the associated application information, an associated GUI resource obtained based on the associated GUI resource information, and associated content obtained based on the associated content information or a service address of at least one external device capable of obtaining at least one of the associated application, the associated GUI resource and the associated content.

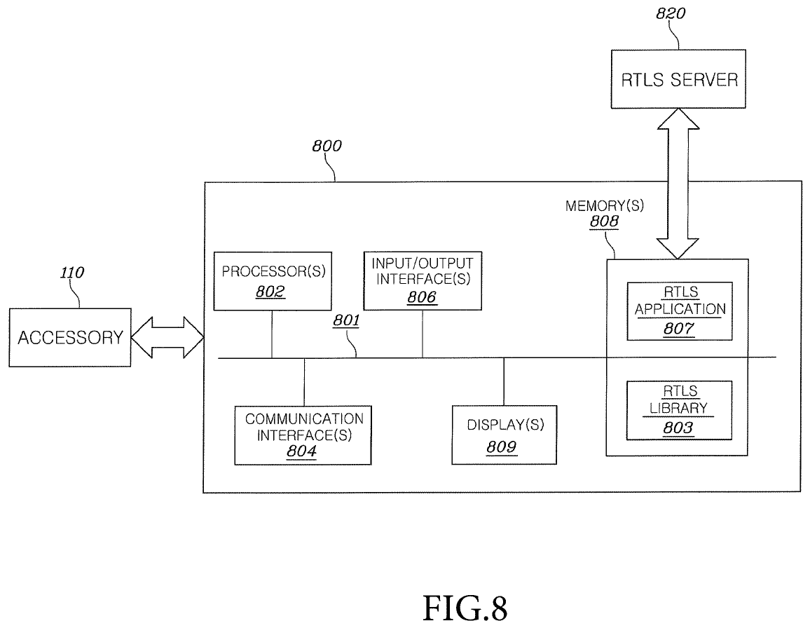

FIG. 8 is a block diagram illustrating an example configuration of an electronic device of a smart accessory system providing an RTLS service according to various embodiments.

Referring to FIG. 8, an electronic device 800 may include a processor(s) (e.g., including processing circuitry) 802, a communication interface(s) (e.g., including communication circuitry) 804, an input/output interface(s) (e.g., including various circuitry) 806, a display(s) 809, and a communication bus(s) 801 for interconnecting such various components. The electronic device 800 may further include a memory(s) 808 coupled to the bus(s) 801 and capable of storing information and instructions to be executed by the processor(s) 802. The electronic device 800 may correspond to the electronic device 1000 of FIG. 10, but may include additional components other than the illustrated components or may omit at least one of the illustrated components. The processor(s) 802, the communication interface(s) 804, the input/output interface(s) 806, the display(s) 809, and the communication bus(s) 801 may perform operations corresponding to components of the same names described in the electronic device 100 of FIG. 3, respectively.

The memory(s) 808 may include at least one RTLS library 803 and an RTLS application 807 capable of providing an RTLS service. The RTLS library 803 may include a location engine performing operations, such as calculating the location coordinate value of a person or thing that is the positioning target and various RTLS libraries, such as a UWB hardware control library. The RTLS application 807 may provide the user with various RTLS functions such as monitoring the positioning target in real time, displaying them on map, positioning-based risk notifications, and positioning-based marketing notifications for the purpose of managing safety, location and movement of persons/things, enhancing performance/sales, and providing the optimized environment.

The processor(s) 802 may include various processing circuitry and receive position information about the positioning target obtained by the UWB module of the accessory 110 from the accessory 110 through the communication interface(s) 804. The processor(s) 802 may calculate the position coordinate value of the positioning target based on the position information, and may provide the calculated position coordinate value to the RTLS application 807. The processor(s) 802 may communicate with the RTLS server 820 through the communication interface(s) 804. The RTLS application 807 may provide an RTLS service in conjunction with the RTLS server 820. For example, the RTLS server 820 may calculate the position coordinate value of the positioning target based on the position information received from the electronic device 800, and may provide the position coordinate value to the electronic device 800. The processor(s) 802 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

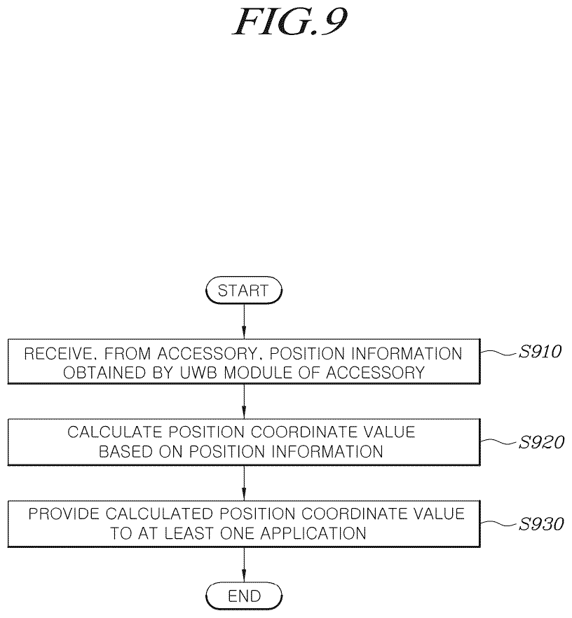

FIG. 9 is a flowchart illustrating an example method for providing an RTLS service by an electronic device of a smart accessory system according to various embodiments.

Referring to FIG. 9, when the accessory 110 includes a UWB module, in operation S910 according to an embodiment, the electronic device 100 may receive position information obtained by the UWB module of the accessory 110 from the accessory 110.

In operation S920, the electronic device 100 may calculate the position coordinate value based on the position information.

In operation S930, the electronic device 100 may provide the calculated position coordinate value to at least one application.

FIG. 10 is a block diagram illustrating an example electronic device 1001 in a network environment 1000 according to various embodiments. Referring to FIG. 10, the electronic device 1001 in the network environment 1000 may communicate with an electronic device 1002 via a first network 1098 (e.g., a short-range wireless communication network), or at least one of an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, or an antenna module 1097. In various embodiments, at least one of the components (e.g., the connecting terminal 1078) may be omitted from the electronic device 1001, or one or more other components may be added in the electronic device 1001. In various embodiments, some of the components (e.g., the sensor module 1076, the camera module 1080, or the antenna module 1097) may be implemented as a single component (e.g., the display module 1060).

The processor 1020 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 1020 may execute, for example, software (e.g., a program 1040) to control at least one other component (e.g., a hardware or software component) of the electronic device 1001 coupled with the processor 1020, and may perform various data processing or computation. According to an embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor adapted to detect a touch, or a pressure sensor adapted to measure the intensity of force incurred by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, a HDMI connector, a USB connector, a SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to an embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the mmWave band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1004), or a network system (e.g., the second network 1099). According to an embodiment, the wireless communication module 1092 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1097 may transmit or receive a signal or power to or from the outside (e.g., the external electronic device) of the electronic device 1001. According to an embodiment, the antenna module 1097 may include an antenna including a radiating element including a conductive material or a conductive pattern formed in or on a substrate (e.g., a printed circuit board (PCB)). According to an embodiment, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097.

According to various embodiments, the antenna module 1097 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 or 1004 may be a device of a same type as, or a different type, from the electronic device 1001. According to an embodiment, all or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In an embodiment, the external electronic device 1004 may include an internet-of-things (IoT) device. The server 1008 may be an intelligent server using machine learning and/or a neural network. According to an embodiment, the external electronic device 1004 or the server 1008 may be included in the second network 1099. The electronic device 1001 may be applied to intelligent services (e.g., smart home, smart city, smart car, or healthcare) based on 5G communication technology or IoT-related technology.

A smart accessory system according to an example embodiment of the disclosure may comprise: an accessory including at least one button, a first communication interface comprising communication circuitry, and at least one first processor comprising processing circuitry, and configured to communicate with an electronic device through the first communication interface, and the electronic device including a second communication interface comprising communication circuitry, a third communication interface comprising communication circuitry, and at least one second processor comprising processing circuitry, configured to communicate with the accessory through the second communication interface, and configured to communicate with a server through the third communication interface. At least one second processor, individually and/or collectively, may be configured to control the electronic device to: receive accessory information from the accessory, transmit the accessory information or the partial information of the accessory information to the server, and receive, from the server, at least one of an associated application, an associated GUI resource, and associated content, or a service address of at least one external device capable of obtaining at least one of the associated application, the associated GUI resource, and the associated content, determined by the server based on the accessory information or the partial information of the accessory information.

According to an example embodiment, at least one second processor, individually and/or collectively, may be configured to map execution of the associated application or execution of a specified function of the associated application to at least one button of the accessory or at least one shortcut of a lock screen of the electronic device, respectively.

According to an example embodiment, the accessory information may include a service policy associated with the accessory, a service ID, and a serial number of the accessory. The partial information of the accessory information may include a service ID. The service ID may include an accessory type. The accessory type may include at least one of a button case, a general case, a charger, a cable, and a pad. The at least one second processor may execute a predetermined application based on the accessory type.

According to an example embodiment, the specified application may be configured to: transmit the accessory information or the partial information of the accessory information to the server, and receive, from the server, at least one of an associated application, an associated GUI resource, and associated content, or a service address of at least one external device capable of obtaining at least one of the associated application, the associated GUI resource, and the associated content, determined by the server based on the accessory information or the partial information of the accessory information.

According to an example embodiment, the specified application may be configured to execute the mapped associated application or execute a predetermined function of the associated application based on a specified button among the at least one button being input.

According to an example embodiment, the accessory may be coupled to the electronic device in a shape of one of a case, a card, and a sticker.

According to an example embodiment, the first communication interface and the second communication interface may include one of NFC, USB, and Bluetooth.

According to an example embodiment, the first communication interface may comprise USB. The accessory may further include a charger configured to receive power from the electronic device or an external power outlet through the first communication interface.

According to an example embodiment, the accessory may further include an antenna including at least one of a directional antenna and a non-directional antenna and a UWB module.

According to an example embodiment, at least one second processor, individually and/or collectively, may be configured to control the electronic device to: receive position information obtained by the UWB module from the accessory, calculate a position coordinate value based on the position information, and provide the calculated position coordinate value to at least one application.

A server according to an example embodiment of the disclosure may comprise: a communication interface comprising communication circuitry, at least one processor comprising processing circuitry, and a database including at least one of associated application information, associated GUI resource information, and associated content information, for each of accessory information corresponding to an accessory coupled to an electronic device or partial information of the accessory information, and at least one processor. At least one processor, individually and/or collectively, may be configured to control the server to: receive the accessory information or the partial information of the accessory information from the electronic device, determine at least one of the associated application information, the associated GUI resource information, and the associated content information based on the accessory information or the partial information of the accessory information in the database, and transmit, to the electronic device, at least one of an associated application obtained based on the associated application information, an associated GUI resource obtained based on the associated GUI resource information, and associated content obtained based on the associated content information or a service address of at least one external device capable of obtaining at least one of the associated application, the associated GUI resource and the associated content.

According to an example embodiment, the accessory information may include a service policy associated with the accessory, a service ID, and a serial number of the accessory. The partial information of the accessory information may include a service ID. The service ID may include an accessory type. The accessory type may include at least one of a button case, a general case, a charger, a cable, and a pad.

A method for providing a smart accessory by an electronic device according to an example embodiment of the disclosure may comprise: receiving accessory information from an accessory including at least one button, transmitting the accessory information or partial information of the accessory information to a server, and receiving, from the server, at least one of an associated application, an associated GUI resource, and associated content, or a service address of at least one external device capable of obtaining at least one of the associated application, the associated GUI resource, and the associated content, determined by the server based on the accessory information or the partial information of the accessory information.

According to an example embodiment, the method may further comprise mapping execution of the associated application or execution of a specified function of the associated application to at least one button of the accessory or at least one shortcut of a lock screen, respectively.

According to an example embodiment, the accessory information may include a service policy associated with the accessory, a service ID, and a serial number of the accessory. The partial information of the accessory information may include a service ID. The service ID may include an accessory type. The accessory type may include at least one of a button case, a general case, a charger, a cable, and a pad. The method may further comprise executing a specified application based on the accessory type.

According to an example embodiment, transmitting, to the server, the accessory information or the partial information of the accessory information to the server, and receiving, from the server, at least one of an associated application, an associated GUI resource, and associated content, or a service address of at least one external device capable of obtaining at least one of the associated application, the associated GUI resource, and the associated content, determined by the server based on the accessory information or the partial information of the accessory information may be performed by the specified application.

According to an example embodiment, the method may further comprise executing the mapped associated application or executing a specified function of the associated application based on a specified button among the at least one button being input.

According to an example embodiment, the accessory may be coupled to the electronic device in a shape of one of a case, a card, and a sticker.

According to an example embodiment, the accessory may further include a charger.

The method may further comprise receiving power from the electronic device or an external power outlet by the charger.

According to an example embodiment, the accessory may further include an antenna including at least one of a directional antenna and a non-directional antenna and a UWB module.

According to an example embodiment, the method may further comprise receiving position information obtained by the UWB module from the accessory, calculating a position coordinate value based on the position information, and providing the calculated position coordinate value to at least one application.

A method for providing a smart accessory by a server according to an example embodiment of the disclosure may comprise: receiving accessory information corresponding to an accessory coupled to an electronic device or partial information of the accessory information from the electronic device, determining at least one of associated application information, associated GUI resource information, and associated content information, based on the accessory information or the partial information of the accessory information, and transmitting, to the electronic device, at least one of an associated application obtained based on the associated application information, an associated GUI resource obtained based on the associated GUI resource information, and associated content obtained based on the associated content information or a service address of at least one external device capable of obtaining at least one of the associated application, the associated GUI resource and the associated content.

According to an example embodiment, the method may further comprise storing at least one of the associated application information, associated GUI resource information, and associated content information for each of the accessory information or partial information of the accessory information in a database.

The electronic device according to various embodiments disclosed herein may be one of various types of electronic devices. The electronic devices may include, for example, a display device, a portable communication device (e.g., a smartphone), a computer device, a portable multimedia device, a portable medical device, a camera, a wearable device, a home appliance, or the like. The electronic devices according to an embodiment of the present disclosure are not limited to those described above.

The various embodiments and terms used herein are not intended to limit the technical features described herein to specific embodiments and should be understood to include various modifications, equivalents, or substitutes of the various embodiments. For example, an element expressed in a singular should be understood as a concept including a plurality of elements unless the context clearly refers only the singular. It should be understood that the term ‘and/or’ as used herein is intended to encompass any and all possible combinations of one or more of the enumerated items. As used in the present disclosure, the terms such as ‘comprise(s)’, ‘include(s)’ ‘have/has’, ‘configured of’, etc. are only intended to designate that the features, components, parts, or combinations thereof described in the present disclosure exist, and the use of these terms is not intended to exclude the possibility of the presence or addition of one or more other features, components, parts, or combinations thereof. In this disclosure, each of the phrases such as “A or B”, “at least one of A and B”, “at least one of A or B”, “A, B or C”, “at least one of A, B and C”, and “at least one of A, B, or C” may include any one of the items enumerated together in a corresponding one of the phrases, or all possible combinations thereof. Terms such as “the first”, “the second”, or “first”, or “second” may be used simply to distinguish a corresponding component from another corresponding component, and do not limit the corresponding components in view of other aspect (e.g., importance or order).

The term “module” or “unit” used in various embodiments of the present disclosure may include a unit implemented in hardware, software, or firmware, or any combination thereof, and be used interchangeably with terms such as e.g., logic, logic block, part, component, or circuitry, for example. The module or unit may be a minimum unit or a part of the integrally configured component or the component that performs one or more functions. For example, according to an embodiment, the module or unit may be implemented in the form of an application-specific integrated circuit (ASIC).

The term “in case ˜” used in various embodiments of the present disclosure, may be construed to refer, for example, to “when ˜” or “when ˜”, or “in response to determining ˜” or “in response to detecting ˜”, depending on the context. Similarly, the term “when it is determined that ˜” or “when it is detected that ˜” may be interpreted to refer, for example, to “upon determining ˜” or “in response to determining ˜”, or “upon detecting ˜” or “in response to detecting ˜”, depending on the context.

The program executed by the electronic device (100), the accessory (110) and the server (120) described herein may be implemented as a hardware component, a software component, and/or a combination of the hardware component and the software component. The program may be executed by any system capable of executing computer readable instructions.

Software may include a computer program, codes, instructions, or a combination of one or more of these, and may configure a processing unit to perform operations as desired or command the processing unit independently or in combination (collectively). The software may be implemented as a computer program including instructions stored in a computer-readable storage medium. The computer-readable storage medium may include, for example, a magnetic storage medium (e.g., read-only memory (ROM), random-access memory (RAM), floppy disk, hard disk, and so on), an optically readable medium (e.g., CD-ROM, digital versatile disc (DVD), or the like) and so on. The computer-readable storage medium may be distributed among network-connected computer systems, so that the computer-readable code may be stored and executed in a distributed manner. The computer program may be distributed (e.g., downloaded or uploaded) by online, either via an application store (e.g. Play Store™) or directly between two user devices (e.g., smartphones). In the case of online distribution, at least a part of the computer program product may be temporarily stored or temporarily generated in a machine-readable storage medium such as a memory of a server of a manufacturer, a server of an application store, or a relay server.

According to various embodiments, each component (e.g., module or program) of the above-described components may include a singular or a plurality of entities, and some of the plurality of entities may be separated and placed into other components. According to various embodiments, one or more components or operations among the above-described corresponding components may be omitted, or one or more other components or operations may be added thereto. Alternatively or additionally, a plurality of components (e.g., a module or a program) may be integrated into one component. In this case, the integrated component may perform one or more functions of each component of the plurality of components identically or similarly to those performed by the corresponding component among the plurality of components prior to the integration. According to various embodiments, operations performed by a module, program, or other component may be executed sequentially, in parallel, repeatedly or heuristically, or one or more of the operations may be executed in a different order or omitted, or one or more other operations may be added thereto.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A smart accessory system, comprising:
an accessory including at least one button, a first communication interface comprising communication circuitry, and at least one first processor comprising processing circuitry, and configured to communicate with an electronic device through the first communication interface; and
the electronic device including a second communication interface comprising communication circuitry, a third communication interface comprising communication circuitry, and at least one second processor comprising processing circuitry, configured to communicate with the accessory through the second communication interface, and configured to communicate with a server through the third communication interface, wherein at least one second processor, individually and/or collectively, is configured to control the electronic device to:
receive accessory information from the accessory;
transmit the accessory information or the partial information of the accessory information to the server; and
receive, from the server, at least one of an associated application, an associated graphical user interface (GUI) resource, and associated content, or a service address of at least one external device capable of obtaining at least one of the associated application, the associated GUI resource, and the associated content, determined by the server based on the accessory information or the partial information of the accessory information.

2. The smart accessory system of claim 1, wherein at least one second processor, individually and/or collectively, is configured to map execution of the associated application or execution of a specified function of the associated application to at least one button of the accessory or at least one shortcut of a lock screen of the electronic device, respectively.

3. The smart accessory system of claim 2, wherein the accessory information includes a service policy associated with the accessory, a service ID, and a serial number of the accessory, wherein the partial information of the accessory information includes a service ID, wherein the service ID includes an accessory type, wherein the accessory type includes at least one of a button case, a general case, a charger, a cable, and a pad, and wherein the at least one second processor, individually and/or collectively is configured to execute a specified application based on the accessory type.

4. The smart accessory system of claim 3, wherein the specified application is configured to:
transmit the accessory information or the partial information of the accessory information to the server; and
receive, from the server, at least one of an associated application, an associated GUI resource, and associated content, or a service address of at least one external device capable of obtaining at least one of the associated application, the associated GUI resource, and the associated content, determined by the server based on the accessory information or the partial information of the accessory information.

5. The smart accessory system of claim 3, wherein the specified application is configured to execute the mapped associated application or a specified function of the associated application based on a specified button among the at least one button being input.

6. The smart accessory system of claim 1, wherein the accessory is coupled to the electronic device and includes one of a case, a card, and a sticker.

7. The smart accessory system of claim 1, wherein the first communication interface and the second communication interface include one of near-field communication (NFC), universal serial bus (USB), and Bluetooth.

8. The smart accessory system of claim 1, wherein the first communication interface includes a universal serial bus (USB), and wherein the accessory further includes a charger configured to receive power from the electronic device or an external power outlet through the first communication interface.

9. The smart accessory system of claim 1, wherein the accessory further includes an antenna including at least one of a directional antenna and a non-directional antenna and an ultra-wideband (UWB) module comprising UWB circuitry.

10. The smart accessory system of claim 9, wherein at least one second processor, individually and/or collectively, is configured to control the electronic device to:
receive position information obtained by the UWB module from the accessory;
calculate a position coordinate value based on the position information; and
provide the calculated position coordinate value to at least one application.

11. A server comprising,
a communication interface comprising communication circuitry;
a database including at least one of associated application information, associated graphical user interface (GUI) resource information, and associated content information, for each of accessory information corresponding to an accessory coupled to an electronic device or partial information of the accessory information; and
at least one processor, comprising processing circuitry, individually and/or collectively, configured to control the server to:
receive the accessory information or the partial information of the accessory information from the electronic device;
determine at least one of the associated application information, the associated GUI resource information, and the associated content information based on the accessory information or the partial information of the accessory information in the database; and
transmit, to the electronic device, at least one of an associated application obtained based on the associated application information, an associated GUI resource obtained based on the associated GUI resource information, and associated content obtained based on the associated content information or a service address of at least one external device capable of obtaining at least one of the associated application, the associated GUI resource and the associated content.

12. The server of claim 11, wherein the accessory information includes a service policy associated with the accessory, a service ID, and a serial number of the accessory, wherein the partial information of the accessory information includes a service ID, wherein the service ID includes an accessory type, and wherein the accessory type includes at least one of a button case, a general case, a charger, a cable, and a pad

13. A method for providing a smart accessory by an electronic device, the method comprising:
receiving accessory information from an accessory including at least one button;
transmitting the accessory information or partial information of the accessory information to a server; and
receiving, from the server, at least one of an associated application, an associated graphical user interface (GUI) resource, and associated content, or a service address of at least one external device capable of obtaining at least one of the associated application, the associated GUI resource, and the associated content, determined by the server based on the accessory information or the partial information of the accessory information.

14. The method of claim 13, further comprising mapping execution of the associated application or execution of a specified function of the associated application to at least one button of the accessory or at least one shortcut of a lock screen, respectively.

15. A method for providing a smart accessory by a server, the method comprising:
receiving accessory information corresponding to an accessory coupled to an electronic device or partial information of the accessory information from the electronic device;
determining at least one of associated application information, associated graphical user interface (GUI) resource information, and associated content information, based on the accessory information or the partial information of the accessory information; and
transmitting, to the electronic device, at least one of an associated application obtained based on the associated application information, an associated GUI resource obtained based on the associated GUI resource information, and associated content obtained based on the associated content information or a service address of at least one external device capable of obtaining at least one of the associated application, the associated GUI resource and the associated content.
